(19) United States
(12) Patent Application Publication
(10) Pub. No.: US 2005/0115425 A1
(43) Pub. Date: Jun. 2, 2005

(54) Valuable document

(76) Inventors: Reinhard Plaschka, Windach (DE); Johann Mueller, Poing (DE); Roger Adamczyk, Muenchen (DE); Peter Franz, Bruck (DE)

Correspondence Address: ROTHWELL, FIGG, ERNST & MANBECK, P.C., 1425 K STREET, N.W., SUITE 800, WASHINGTON, DC, 20005, US

(21) Appl. No.: 10/498,780

(22) PCT Filed: Dec. 12, 2002
(86) PCT No.: PCT/EP02/14161

(30) Foreign Application Priority Data
Dec. 17, 2001 (DE) 101620500

(51) Int. Cl. B41M 1/10

(52) U.S. Cl. 101/170

(57) ABSTRACT

The invention relates to a data carrier printed with a tactile halftone image, a method for producing it and a printing plate suitable therefor.

### CROSS-REFERENCE TO RELATED APPLICATIONS

This application is National Phase of International Application No. PCT/EP02/14161, filed Dec. 12, 2002.

### FIELD OF THE INVENTION

This invention relates to a data carrier printed with a tactile halftone image, a method for producing it and a printing plate suitable therefor.

### DESCRIPTION OF THE BACKGROUND ART

Data carriers according to the invention are in particular security documents or documents of value such as bank notes, ID cards, passports, check forms, shares, certificates, postage stamps, plane tickets and the like as well as labels, seals, packages or other elements for protecting products. The simple designation “data carrier” and “security document or document of value” hereinafter will therefore always include documents of the stated type.

Such papers, whose commercial or utility value far exceeds their material value, must be recognizable as authentic and distinguishable from imitations and forgeries by suitable measures. They are therefore provided with special security elements that are ideally not imitable or falsifiable, or only with great effort.

In the past particularly those security elements have proved useful that are identified and recognized as authentic by the viewer without aids but can simultaneously only be produced with the greatest effort. These are e.g. watermarks, which can only be incorporated in the data carrier during papermaking, or motifs produced by intaglio printing, which are characterized by their tactility which cannot be imitated by copying machines.

Line or intaglio printing, in particular steel intaglio printing, is an important technique for printing data carriers, in particular papers of value such as bank notes and the like.

Intaglio printing is characterized in that linear depressions are formed in the printing plates to produce a printed image. The ink-transferring areas of the plate are thus present as depressions in the plate surface. Said depressions are produced by a suitable engraving tool or by etching. The mechanically fabricated plate for intaglio printing produces a wider line with increasing engraving depth due to the usually tapered engraving tools. Furthermore, the ink receptivity of the engraved line and thus the opacity of the printed line increases with increasing engraving depth.

In the etching of intaglio printing plates, the nonprinting areas of the plate are covered with a chemically inert lacquer. Subsequent etching produces the engraving in the exposed plate surface, the depth of the engraved lines depending in particular on the etching time. Before the actual printing operation, ink of pasty consistency is applied to the engraved plate and the surplus ink removed from the surface of the plate by a wiping blade or cylinder so that ink is left behind only in the depressions. A substrate, normally paper, is then pressed against the plate and thereby also into the ink-filled depressions of the plate, and removed again, whereby ink is drawn out of the depressions of the plate, sticks to the substrate surface and forms a printed image there. If transparent inks are used, the thickness of the inking determines the color tone. Thus, a light color tone is obtained when printing a white data carrier with small ink layer thicknesses, and darker color tones when printing with thick ink layers. Ink layer thickness is in turn dependent on engraving depth to a certain extent.

Line intaglio printing permits relatively thick inking on a data carrier in comparison to other common printing methods, such as offset. The comparatively thick ink layer produced by line intaglio, together with the partial deformation of the paper surface resulting from the paper being pressed into the engraving of the plate, is easily feelable manually even to the layman and thus readily recognizable as an authenticity feature on the basis of its tactility. The tactility cannot be imitated with a copier so that line intaglio printing offers high-grade protection against forgeries.

Such printed images can be printed all over only with special additional effort, since the unengraved surfaces of the printing plate usually do not transfer any ink to the paper being printed, so that the printed image is normally always limited to motifs composed of narrow lines. A combination of all-over printing with tactility is impossible with conventional intaglio printing.

A further intaglio printing technique to be distinguished from line intaglio is rotogravure. Rotogravure, in particular halftone rotogravure, is characterized in that different gray or color values of the printed image are produced by cells disposed regularly in the printing plate, spaced with wide bars and having different density, size and/or depth. In rotogravure the printing plates are produced for example mechanically by means of graving tools or by removal by electron beam or laser beam. Rotogravure typically uses fluid ink and a doctor blade. The principle of the printing operation is based on the cells being filled with fluid ink and ink being held in the cells of different depth. The screen bars limiting the cells serve as a support for the doctor blade but are nonprinting themselves. In printing, the limits between adjacent print areas fuse due to the fluidity of the ink, however, so that said areas are no longer precisely separable. This results quasi in an all-over printed image. However, the lack of viscosity of the ink and the low contact pressure prevent relief formation so that the printed image has no tactility.

Conventional rotogravure and line intaglio therefore have the disadvantage that no tactility in the printed image along with all-over printing can be realized in one printing cycle.

### SUMMARY OF THE INVENTION

The problem of the present invention is to provide a data carrier with elevated forgery-proofness that has a picture motif that is both tactile and difficult to imitate by printing technology and optically striking since produced by intaglio printing.

A further problem is to provide a printing plate for producing the inventively printed data carrier and a corresponding production method.

The invention is based on the printed image provided on the data carrier and produced by intaglio printing being a halftone image. Said halftone image includes directly adjacent printed partial surfaces in at least a partial area of the image, the partial surfaces having certain tonal values and at least a partial area of the image being perceptible tactilely.

“Halftone image” designates according to the invention an image having intermediate tones between the lightest and darkest places of the image. If a black-and-white image is involved, “tonal value” refers as usual to a value on a gray scale from white to black. However, the present invention does not relate only to black-and-white halftone images containing achromatic colors, namely white, black and gray, but of course also to one- or multicolor halftone images including so-called chromatic colors. In the case of chromatic halftone images, “tonal value” refers to the brightness of the color in question. The inventive image preferably includes at least three tonal values. If the basic color of the substrate to be printed, e.g. the white of the paper, is integrated into the design of the image, the image preferably has four tonal values, e.g. white, black and two gray values. In especially preferred embodiments, the printed image has a much greater tonal-value range, so that not only light and shadow effects but also three-dimensional effects can be achieved. The finer the tonal-value gradations, i.e. the greater the tonal-value scale, the better motifs can be represented three-dimensionally, and the printed image ideally approaches a photographic representation whereby the tonal-value gradations pass into one another quasi continuously. Tests have shown, however, that four halftone steps already convey a very realistic halftone impression. At six halftone steps, the layman already sees relatively little difference over the photographic halftone image.

The halftone image can represent any desired motif. However, pictorial representations are preferred. Representation of portraits is especially preferred, since human perception is trained to see extremely fine differences in portraits, so that the recognition value and thus protection value of this security element is especially great. A plurality of halftone images can also be combined in any desired number and form.

Since conventional intaglio inks are transparent and translucent to a certain degree, color or gray tones of different brightness and color saturation result with suitable layer thicknesses and expedient choice of background color. The different brightnesses according to the invention, hereinafter designated “tonal values,” can thus be produced solely via the ink layer thickness, i.e. the printed partial surfaces of different tonal values are printed with an ink layer of different thickness. Thus, light color tones are obtained when printing a white data carrier with small ink layer thicknesses, and darker color tones when printing with thick ink layers. It is also possible that not only brightness but also color saturation changes in accordance with layer thickness depending on the ink and substrate used. Normally, ink layer thickness mainly influences brightness value and saturation, however. The influence of layer thickness on saturation and brightness is to be determined accordingly in each individual case, i.e. for each ink and substrate. If there is sufficient difference in the ink layer thicknesses of adjacent surfaces, readily visible contrasts result for the human eye without any aids. This assumes normal lighting conditions and a normal viewing distance.

To produce an inventive printed image, an original, preferably a portrait, is first subdivided into tonal value-based partial surfaces. The individual tonal values or groups of tonal values of this conversion are then assigned different engraving depths for the printing plate to be produced, coordinated with the ink being used. For example, maximum engraving depth for black and minimum engraving depth or unengraved for white. All tonal values of the original are to be converted into corresponding engraving depths on the printing plate accordingly. The engraving depth of the plate necessary for producing a special tonal value varies from ink to ink.

Which assignment is necessary can be easily determined by proofing a stepped gray wedge with the ink under discussion. The gray wedge has for this purpose a plurality of surface elements that are lined up and differ in defined engraving-depth steps. For example, if the engraving depth is varied in 5-micron steps, the gray wedge begins with a field with an engraving depth of 5 microns, the next field has an engraving depth of 10 microns, the next 15 microns, etc., up to an engraving depth of e.g. 100 microns. The field size is for example 5×5 millimeters. The individual fields are separated only by narrow separation edges.

If the gray wedge is now printed with a special ink, one will ascertain that the first field has a special light tonal value that contrasts with the next field, the next fields each having darker tonal values up to a field where the darkest tonal value is present. From this field on there is no more tonal-value variation. Depending on how many tonal values are to be used in the later halftone image to be printed, they are assigned to the particular fields of the gray wedge, thereby also obtaining the engraving depths required for producing the printing plate.

This gray-wedge test is to be done separately for each ink. If an ink has a deficient “transparency bandwidth,” i.e. too few tonal values contrasting with increasing engraving depth, it can be adapted by measures known to the expert.

If a halftone image wherein the engraving depths of the tonal-value areas are coordinated with the ink transparency is printed, a halftone resolution is obtained without the otherwise usual screen technique. The tonal values are based solely on the transparency of the inks. Additionally, the printed halftone image has a surface relief in which the darker parts are formed higher than the light ones.

“Partial surfaces” designate according to the invention surfaces constituting the halftone image. The partial surfaces are printed and possibly unprinted surfaces, at least a portion of the printed partial surfaces being directly adjacent. “Directly adjacent” means that the adjacent partial surfaces are not separated by unprinted areas in the printed image. Preferably, the proportion of printed partial surfaces is greater than the proportion of unprinted partial surfaces in the inventively printed halftone image. It is also preferable for the printed partial surfaces to be predominantly adjacent so that the inventively printed halftone image arouses the impression of a substantially all-over print. The adjacent partial surfaces can have different tonal values, i.e. different ink layer thickness, but also the same tonal values, i.e. the same ink layer thickness. In particular, unprinted surfaces are used mainly for design purposes, for example to represent light reflexes or shiny places.

To increase the stability of the data carrier it can be expedient to cover the inventive halftone image with a coating, such as a lacquer layer. Said lacquer can contain feature substances, such as luminescent substances, etc., or other effect pigments, such as liquid-crystal pigments. Moreover, the lacquer can be executed in matt or glossy form. In addition, the protective lacquer layer serves to increase the glossy effect and to protect the print.

Suitable substrates or data carrier materials are all substrate materials that can be used for intaglio printing, such as paper, plastic foils, coated paper or paper laminated with plastic foils and multilayer composite materials. In particular, the inventive method is suitable for printing data carriers that must meet high standards with respect to forgery-proofness, such as security documents and documents of value, for example bank notes, shares, bonds, certificates, vouchers and the like.

Particularly complex printed images can be rendered by adjoining printed areas and surfaces with different ink layer thickness directly and in any order. This enormously increases the freedom of design in preparing and rendering printed images produced by intaglio printing.

The inventive method for producing corresponding printed data carriers has in addition considerable economic advantages, since the surfaces provided for printing with different ink layer thicknesses are produced in a single printing pass with one and the same ink.

The forgery-proofness of the inventive security element or security print can finally be increased further if there is a frequent change between the different tonal values of the partial surfaces. The partial surfaces differ here with respect to their superficial extent and/or their light/dark contrast and/or their tactility. The exact register between the different printed partial surfaces and the resulting special optical impression of the security print can only be produced by intaglio printing, i.e. using a printing plate in which the security print is engraved completely and with the necessary register. The predominant portion of the ink-carrying partial surfaces is advantageously directly adjacent so that a substantially all-over printed image is present in the later printed image.

The inventive intaglio printing plates are preferably produced by engraving with a fast-rotating, tapered graver, for example by a method described in WO 97/48555. The engravings can fundamentally also be produced by means of laser engraving or etching or any other suitable removal method.

In order to prevent directly adjacent ink layers from flowing into each other along their boundary line before the ink dries after being transferred to a data carrier, so-called “separation edges” are integrated into the printing plate between surfaces with different engraving depth according to WO 00/20216 and WO 00/20217. Said separation edges have a tapered, wedge-shaped cross-sectional profile. The tip of the wedge is preferably located at the height of the printing plate surface or slightly thereunder.

The tip of the separation edge profile forms a largely one-dimensional line similar to a knife blade along the separation edge. It separates the printing plate areas of different engraving depth, but does not produce an ink-free interruption of the printed ink surfaces. With the support of the separation edge integrated into the printing plate, the intaglio ink, which is of pasty consistency, is left “standing” in dimensionally stable fashion after its transfer to a substrate even when surfaces printed with different layer thickness directly abut. This permits extremely fine, superimposed structures with different ink layer thickness and high edge sharpness to be printed by intaglio printing.

If the engravings of the printing plate are not inked, or at least not completely inked, that is, filled with ink, before the printing operation, the uninked area of the plate acts only as an embossing plate, which can be used to produce so-called blind embossings on a substrate during the intaglio printing operation. The embossed elements have similar proportions and tactile properties to the above-described printed surfaces, just without the visual impression produced by the ink.

The thus produced printing plate is finally used to print the data carrier.

The high contact pressure during intaglio printing additionally subjects the substrate material to an embossing which also stands out on the back of the substrate.

The procedure for converting a halftone original into an inventive printed image is preferably as follows:

1. Defining the number of tonal values for rendering the halftone original (e.g. a photo) by printing technology.

It should be noted here once again that the more tonal values are used, the closer one comes to the appearance of the original. However, tests have shown that five or six tonal values already permit a sufficiently precise halftone rendition.

2. Preparing the tonal-value separations from the halftone original.

3. Defining the ink for rendering the halftone motif by printing technology.

4. Determining the transparency range of the ink (unless already done) and assigning tonal values to ink layer thicknesses or engraving depths.

5. Defining the partial surfaces of the printing plate to be produced by defining the surface areas with defined engraving depth, defining the separation edges, ink trap structures, etc.

6. Producing the printing plate by removing the particular layer areas, preferably by engraving technology according to WO 97/48555.

7. Proofing the specimen prints for evaluating the printing conversion and making any necessary corrections.

The inventively printed data carriers have elevated forgery-proofness since they are not reproducible with common printing processes due to the characteristic intaglio printed image. This exactly registered positioning of the partial surfaces is not possible by superimposing two printed images produced by successive, mutually independent printing or embossing operations.

The tactilely perceptible picture elements additionally offer effective protection against imitation by color photocopying or scanning of the data carriers.

Intaglio printing, in particular steel intaglio printing, thus provides a characteristic printed or embossed image that is readily recognizable even to laymen and cannot be imitated with other common printing processes. Steel intaglio printing is therefore preferably used for printing data carriers, in particular security documents and documents of value, for example bank notes, shares, bonds, certificates, vouchers and the like, which must meet high standards with respect to forgery-proofness.

### BRIEF DESCRIPTION OF THE DRAWINGS

The following examples and supplementary figures will serve to explain the advantages of the invention. The described single features and examples described hereinafter are inventive when taken alone, but also inventive in combination. The examples involve preferred embodiments, but the invention is by no means to be restricted thereto. The proportions shown in the figures do not necessarily correspond to actually existing relations and serve primarily to improve the clarity.

FIG. 1 shows a bank note in a front view,

FIG. 2 shows a halftone image original,

FIG. 3 shows a halftone image original converted into tonal-value separations,

FIG. 4 shows an inventive halftone image with partial surfaces,

FIG. 5 shows a halftone image original, superimposed with a pixel screen,

FIG. 5a shows a detail of FIG. 5,

FIG. 5b shows a front view of an inventive printed image,

FIG. 6 shows a halftone image original converted into tonal-value separations, superimposed with a pixel screen,

FIG. 6a shows a detail of FIG. 6,

FIG. 6b shows a front view of an inventive printed image,

FIG. 7 shows a halftone image original, superimposed with tonal value-based partial surfaces,

FIG. 8 shows a halftone image original converted into tonal-value separations, superimposed with a line screen,

FIG. 8a shows a detail of FIG. 8,

FIG. 8b shows a front view of an inventive printed image,

FIG. 9 shows a halftone image original, superimposed with a line screen,

FIG. 9a shows a detail of FIG. 9,

FIG. 9b shows a front view of an inventive printed image,

FIG. 10 shows a further variant of an inventive printed image,

FIGS. 10a and 10b show details of FIG. 10 with fine structures,

FIG. 11 shows a further variant of an inventive printed image,

FIG. 12 shows a front view of an inventive printed image with additional tactile structural elements,

FIG. 12a shows a cross section through an inventive printing plate,

FIG. 12b shows a cross section through an inventive data carrier along A-A in FIG. 12,

FIGS. 13 and 14 show cross sections through an inventive printing plate,

FIG. 15 shows a cross section through an inventive data carrier.

### DETAILED DESCRIPTION OF THE INVENTION

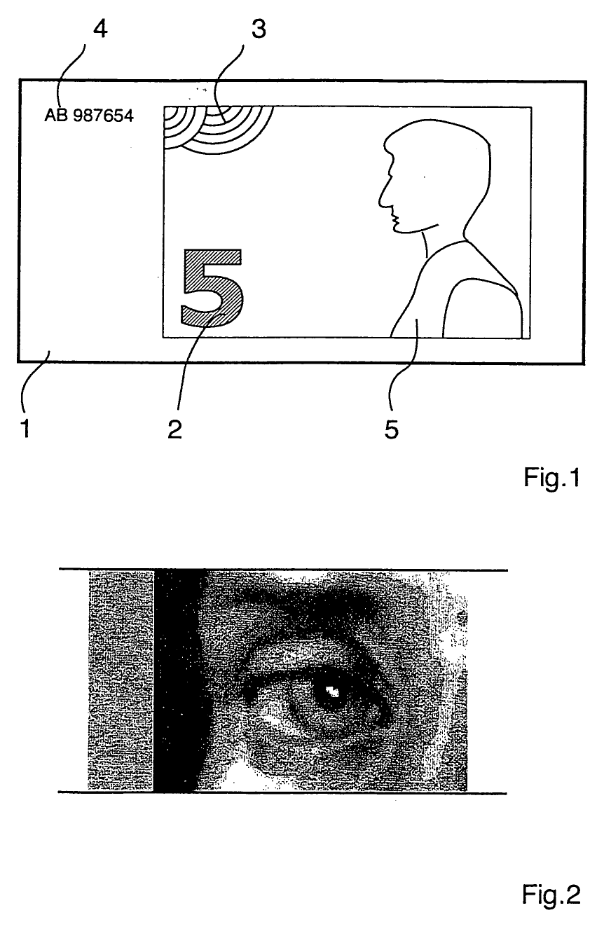

FIG. 1 shows a sketch of a bank note as data carrier 1. The printed image of a bank note is typically a superimposition of a plurality of printed images each produced separately by a different printing process. The depicted bank note shows for example printed image 2 representing the numeral 5. Printed image 2 is realized by conventional intaglio printing, which means that different brightnesses are rendered by line screens with varying line distance or line width. Further, background pattern 3 of fine lines produced by offset, and serial number 4 applied by letterpress, are present. In addition, partial areas produced by screen printing might be provided, etc.

Inventive print 5, which is to show a portrait, is provided in a partial area of the bank note in the example shown here and rendered only schematically. The precise description of the inventive print, the printed data carrier and the printing plate used will be explained with reference to the following examples and figures.

FIG. 2 shows a halftone image that is to serve as the original for the inventive printed halftone image. In the present case this is a black-and-white photograph, which usually does not have any grid recognizable to the naked eye. The grid visible in FIG. 2 is only selected secondarily to make the “photo” capable of being duplicated by printing technology. The original of FIG. 2 shows a detail of a portrait and is to be understood as a classic halftone image containing a plurality of intermediate tones between the lightest tonal value, white here, and the darkest tonal value, black here.

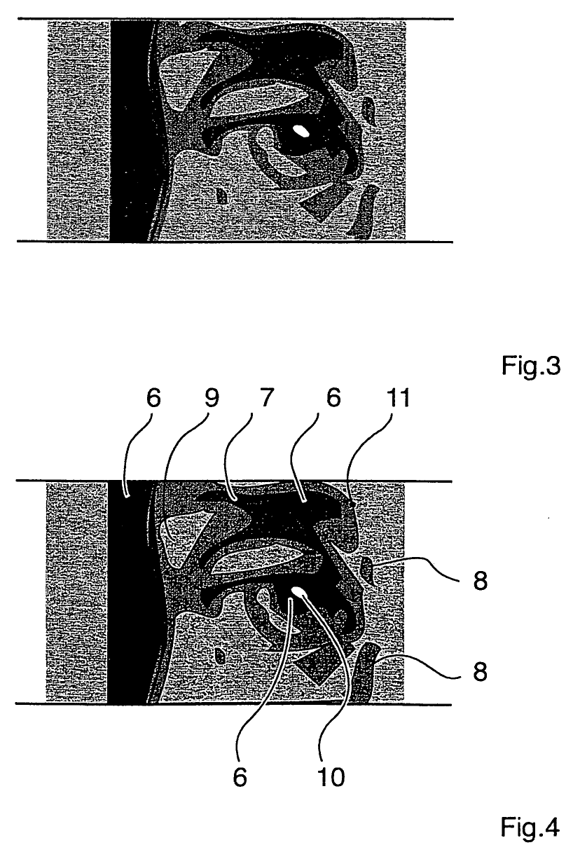

According to the invention, halftone separations are prepared from the halftone original. FIG. 3 shows e.g. a halftone original from tonal-value separations with five tonal values, namely white, light gray, medium gray, dark gray and black, which have been derived from the halftone original as shown in FIG. 2. Said originals according to FIG. 2 and FIG. 3 can now be superimposed by a screen, whereby the individual partial surfaces (pixels) resulting from the screening are assigned certain tonal values.

The original can be broken down into partial surfaces using any desired forms of screen. Both simple, regular, geometrical structures and randomly distributed, irregular and complicated structures can be used. The limits of the partial surfaces can likewise be defined at will.

It is thus possible to use for instance parallel, almost parallel, spiral-shaped, star-shaped, intersecting or intertwined line systems with a zigzag, wavy, arcuate, circular or straight course, guilloches, geometrical structures such as circles, ellipses, triangles and other polygons.

The various described screen variants for breaking down a printed image into partial surfaces can of course also be combined. The original can be divided into partial surfaces at will, the only restriction being that printed partial surfaces are adjacent at least in a partial area of the printed halftone image.

The original image converted into partial surfaces with certain tonal values is in turn assigned the engraving depths for converting the original into an engraving on an intaglio printing plate. The engraving depths are ink-dependent and determined substantially by the transparency bandwidth of the ink to be used.

The following examples will explain various embodiments of the invention by way of example.

### EXAMPLE 1

If a most realistic copy of the master is to be obtained, it is expedient to perform the screening as an areal resolution of the original image. This variant is shown in FIG. 4. Partial surfaces 6, 7, 8, 9 and 10 are thus obtained from the original itself. This means that the partial surfaces are based on a pictorial section in the original. This is effected automatically in the preparation of halftone separations whereby areas corresponding to a certain tonal-value range are assigned partial surfaces which are then rendered with a uniform tonal value. This leads to areally resolved originals in which the particular tonal values are subdivided into tonal-value ranges and each tonal-value range rendered by a defined tonal value. In the case of e.g. five tonal-value ranges, the total range of tonal values 0 to 100% is subdivided e.g. into five equal parts, i.e. from 1 to 20%, from 21 to 40%, from 41 to 60%, etc. Then each of the tonal-value ranges is rendered collectively by e.g. the highest tonal value of the individual range, i.e. the tonal values from 1 to 20% are rendered by a uniform tonal value of e.g. 20%, those from 21 to 40% by a tonal value of 40%, etc. The tonal values of the stated example are thus 0%, 20%, 40%, 60%, 80% and 100%. However, the tonal-value ranges can also be selected irregularly, e.g. 0%, 30%, 60%, 80%, 90%, 100%. In this case, lighter image areas are e.g. given less weight than dark image parts. It is also to be heeded that a tonal-value separation usually does not represent a contiguous surface but consists of individual island-like areas, which may be distributed over the entire image surface, so that each of said island-like areas is to assigned an inventive partial surface with the corresponding tonal value. The partial surfaces belonging to a tonal-value separation are characterized by a uniform engraving depth or ink layer thickness in the total printed image. The screen superimposed on the original is in this case adapted precisely to the boundary lines of the surfaces that represent certain tonal values. Looking at the image shown in FIG. 4, this would result e.g. in three black partial surfaces 6 having the dimensions of the black areas in the original. In addition, the corresponding partial surfaces for the dark gray (7), medium gray (8), light gray (9) and white areas (10) would be present. The dimensions of the partial surfaces and thus the later engraving thus result directly from the image surfaces in the original. When the dimension of the partial surface as well as the assigned tonal value and the related engraving depth are established, all necessary data for converting the original into an engraving are known.

Black separating lines 11 shown in FIG. 4 are normally invisible in the printed image. They serve only to illustrate the limits of the partial surfaces better. In the printed image the partial surfaces are directly adjacent in the area of said black lines without being separated by lines. If a printing plate with the above-described separation edge extending to just under the plate surface is used, a very fine, light, but inked, i.e. printed, line might be seen in the printed image in the area of the black lines shown in FIG. 4. Partial surface 10 appearing white in the printed image is an unprinted place in the otherwise all-over printed image, assuming the substrate to be printed is white.

### EXAMPLE 2

Besides the method described in Example 1 of determining the partial surfaces in dependence on the picture motif, it is also possible to bring the original in congruence with a separately produced screen to produce the partial surfaces of the printed image. According to this embodiment, a screen is placed over the original image, i.e. the original is split into partial surfaces quite independently of the motif. Said partial surfaces, which correspond to the partial surfaces in the later inventive printed image, are assigned tonal values. The finer the screen, in other words, the smaller the partial surfaces constituting the inventive halftone image, the more image details can be rendered. Said tonal values are then converted into engraving depths for the printing plate, as described above.

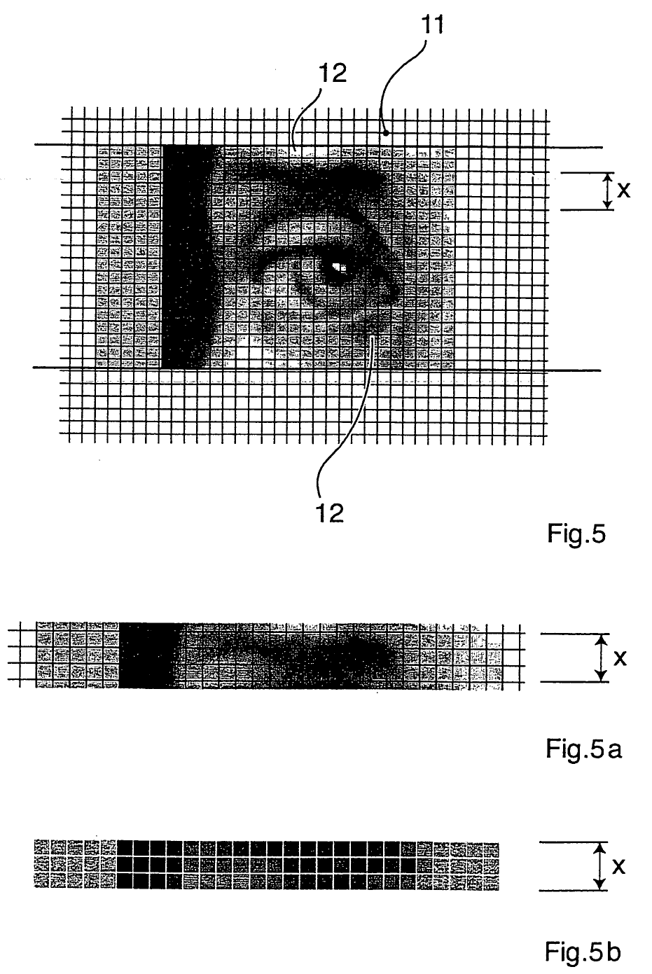

In the simplest case, a pixel screen is used. In FIG. 5, the original from FIG. 2 has been superimposed with such a screen. This causes the original to be resolved into uniform square partial surfaces 12. One partial surface 12 is thus represented by a box/pixel. FIG. 5a shows a detail of FIG. 5, the section designated “x.” As explained in Example 1, the black lines in FIG. 5 and FIG. 5a serve only to delimit the partial surfaces. They are not visible as black lines in the printed image.

Each box or pixel is assigned a certain tonal value in the next step. If a plurality of tonal values are present in a box, an average is formed for example by integration and then determines the tonal value of the pixel. Since the classic halftone image according to FIG. 2 has been used as the original, this method provides a plurality of tonal values which are converted into corresponding engraving depths.

In contrast to known rotogravure printing plates, the inventive engraved areas for the pixels are so closely adjacent that separation is only effected via above-described separation edges. The separation edges in the plate “physically” separate the individual pixels (cells), but by printing technology they cause a direct transition from pixel to pixel despite the pasty ink. The pixels are thus not separated by unprinted bars, at best by lighter printed lines. Said lines are usually extremely fine so that they are inconspicuous in the printed image. The thus produced image is shown in FIG. 5b, the individual boxes already being assigned the corresponding tonal values here. The light lines in FIG. 5b indicate how the separation edges are set during engraving of the plate and how the partial surfaces are adjacent in the printed image. They do not stand for fully unprinted lines.

To guarantee the clarity of the representation, the shown screen is relatively coarse. The image converted via partial surfaces with certain tonal values will therefore appear relatively abstract. If a more precise copy is to be produced, a screen with a substantially smaller screen width will of course be selected so that the produced pixels are much smaller and less perceived as individual boxes by the human eye.

### EXAMPLE 3

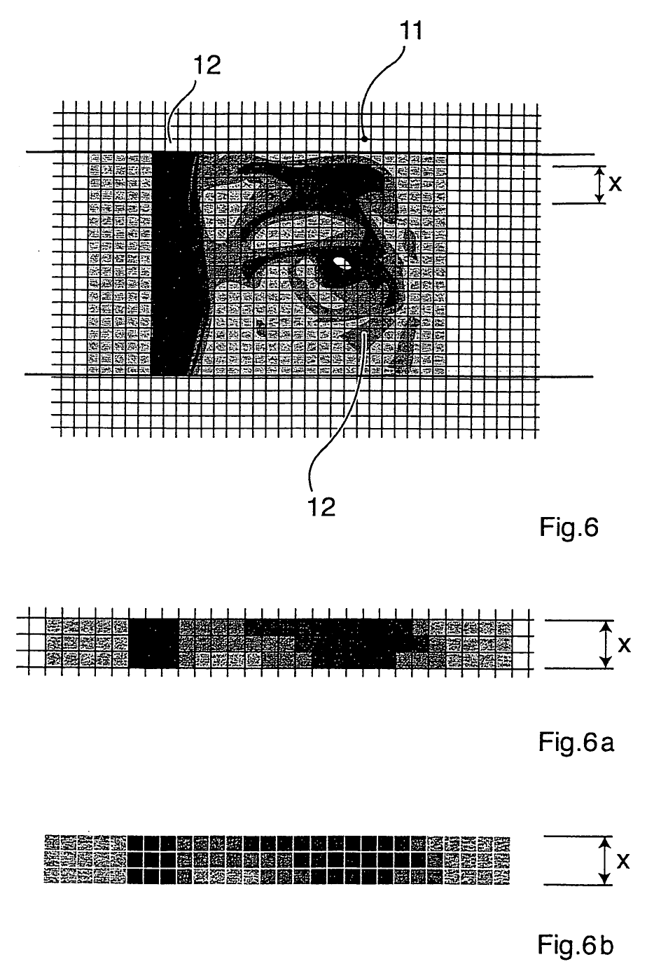

The example illustrated in FIG. 6, FIG. 6a and FIG. 6b is based, like Example 2, on the use of a pixel screen. The difference, however, is that not the classic halftone image from FIG. 2 is superimposed with the screen, but the halftone image from FIG. 3 constructed from halftone separations.

As in Example 2, each individual pixel is assigned a certain tonal value. Since the original is limited to five tonal values, the image converted into pixels also has only five tonal values, as shown in FIG. 6a. That is, the image is constructed here from a defined number of tonal values and according engraving depths.

FIG. 6 shows the halftone image from five tonal-value separations superimposed with the pixel screen. FIG. 6a shows detail “x” indicated in FIG. 6 wherein tonal values have already been assigned to the pixels. FIG. 6b shows the printed image associated with FIG. 6a, one pixel corresponding to one partial surface 12.

The remarks under Example 2 apply analogously here.

### EXAMPLE 4

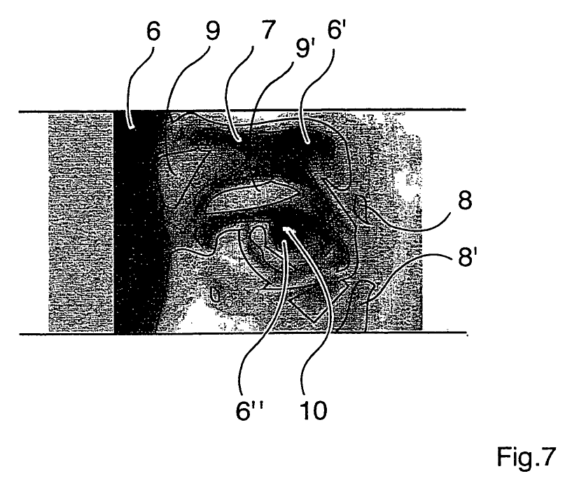

As shown in FIG. 7, partial surfaces are again defined here starting out from the halftone separations according to FIG. 4, said surfaces being produced from the picture motif itself. They are represented by black lines 11. Said partial surfaces are then superimposed by the classic halftone image according to FIG. 2.

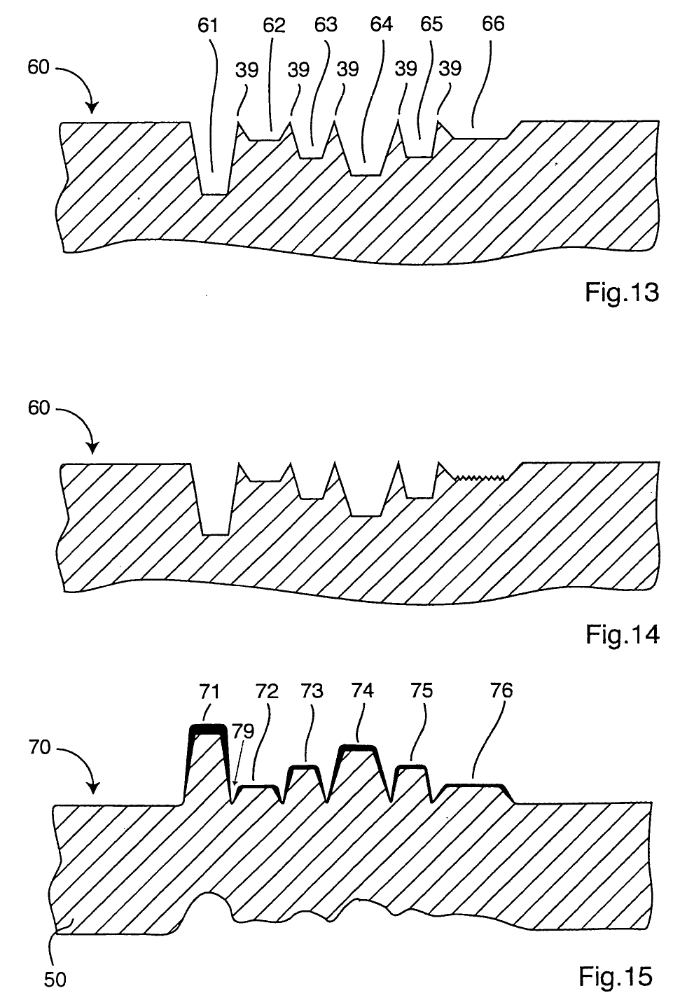

The individual partial surfaces can then be assigned certain tonal values which, in contrast to Example 1, are not limited to five tonal values but can correspond to a plurality of tonal values in the original. That is, black partial surfaces 6, 6′ and 6″ are not, as in Example 1, realized exclusively as black partial surfaces 6 but can be further differentiated by different dark-gray to black tonal values. The same holds for dark-gray partial surfaces 7 and 7′ and medium-gray partial surfaces 8 and 8′. It is additionally not only possible to assign a partial surface a very specific tonal value, but also possible to represent tonal-value patterns within a partial surface. Said patterns can be realized in the printing plate by printing technology with the aid of inclined planes, which might be additionally equipped with separation bars or ink trap bars, as explained for Example 8 and FIG. 14.

### EXAMPLE 5

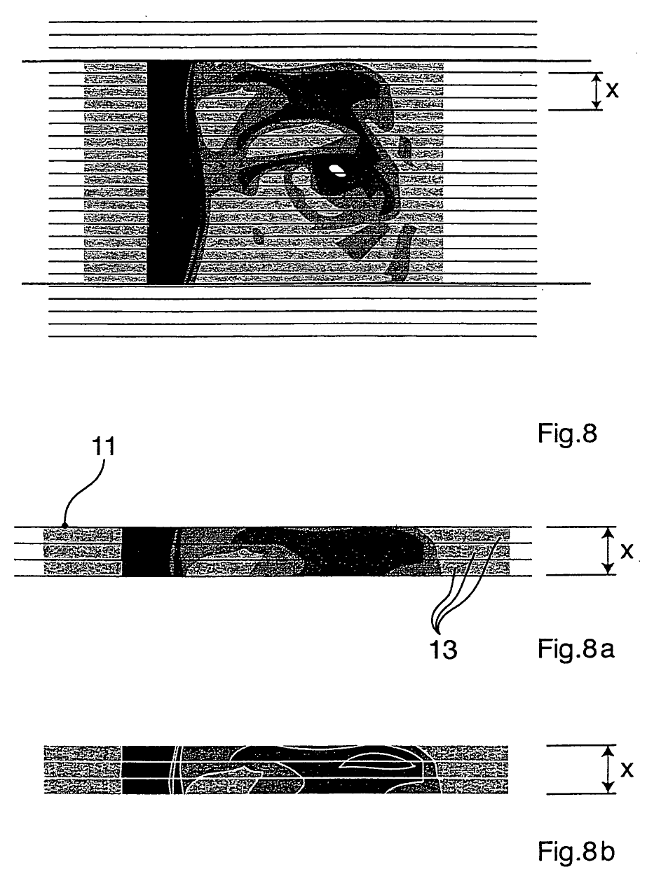

As shown in FIG. 8, a line screen can be used, alternatively to the pixel screen, for dividing the halftone original according to FIG. 3 superimposed therewith into closely adjacent strips 13. In this variant the original is superimposed with horizontal parallel lines 11. In this case, however, each strip is not assigned a uniform tonal value, but the tonal value varies within a strip according to the tonal-value separations produced in step 2 if the tonal-value separations vary along the strip. A partial surface is thus limited on the right and left as well as top and bottom by separating lines 11, or in the printing plate by separation edges. Delimitation to the left and right results from the picture motif and extends along the surfaces having a certain tonal value; the separating lines at the top and bottom result from the superimposed line screen. Partial surfaces that do not fill a line over the whole width are either averaged over the line width and then assigned to the particular tonal values in accordance with the average, or they are delimited with separating lines within the strip, as shown.

FIG. 8a shows the section designated “x” in FIG. 8 in which three strips 13 are marked by way of example. FIG. 8b shows the printed image corresponding to section “x.”

The light borders of the partial surfaces in FIG. 8b serve again to illustrate the exact dimensions of the partial surfaces and indicate the use of separation edges in the printing plate.

The strips and the areas within the strips that have been assigned different tonal values are separated by means of separation edges here. If the lines of the line screen extend at right angles to the wiping direction of the wiping cylinder or blade, this division will probably suffice. If the line screen extends along the wiping direction, longer partial areas within the strips that are assigned to a tonal value might have to be interrupted with further separation edges in order to prevent ink from “splashing out” during the printing operation. The separation edges might produce thin, light printed lines in the later printed image. If this is to be avoided, so-called “ink trap elements” can be provided within the screen lines also in the area of the plate surface, as described for Example 8 and FIG. 14. They do not protrude as far as the plate surface and are less conspicuous in the later printed image than separation edges.

### EXAMPLE 6

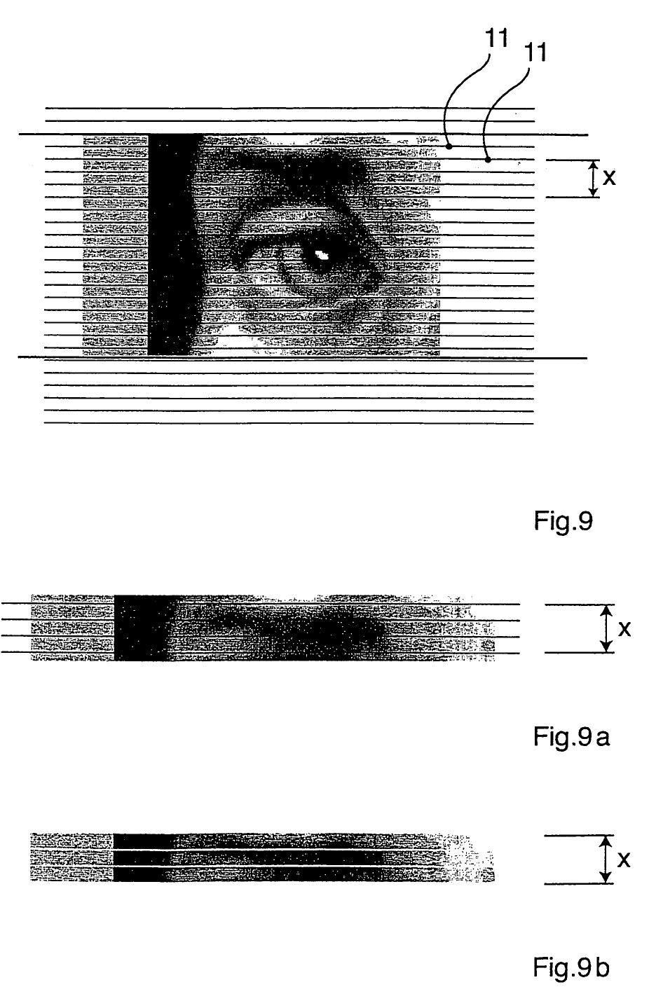

The variant shown in FIG. 9 differs from the embodiment described in Example 5 and FIGS. 8 to 8b in that the original superimposed with a line screen is not an image based on halftone separations according to FIG. 3 but the classic halftone image according to FIG. 2. The partial surfaces are delimited at the top and bottom by individual lines 11, as in Example 5, whereby any number of tonal values can be present in the individual lines, as clearly visible in FIG. 9a. The tonal-value pattern within a strip is realized by printing technology using a printing plate in which inclined planes are engraved within a strip that is in turn delimited from the next strip by separation edges. Due to the inclined plane in the printing plate, a continuously increasing or decreasing ink layer thickness is produced on the data carrier, which a viewer perceives as a continuously lightening or darkening tonal value. As described in Example 5, separation edges within the individual strips are also recommendable. It is additionally possible to engrave ink trap structures in order to prevent running or splashing between the tonal-value areas and lines. The light lines in FIG. 9b show the partial surfaces in the printed image delimited from each other by separation edges.

### EXAMPLE 7

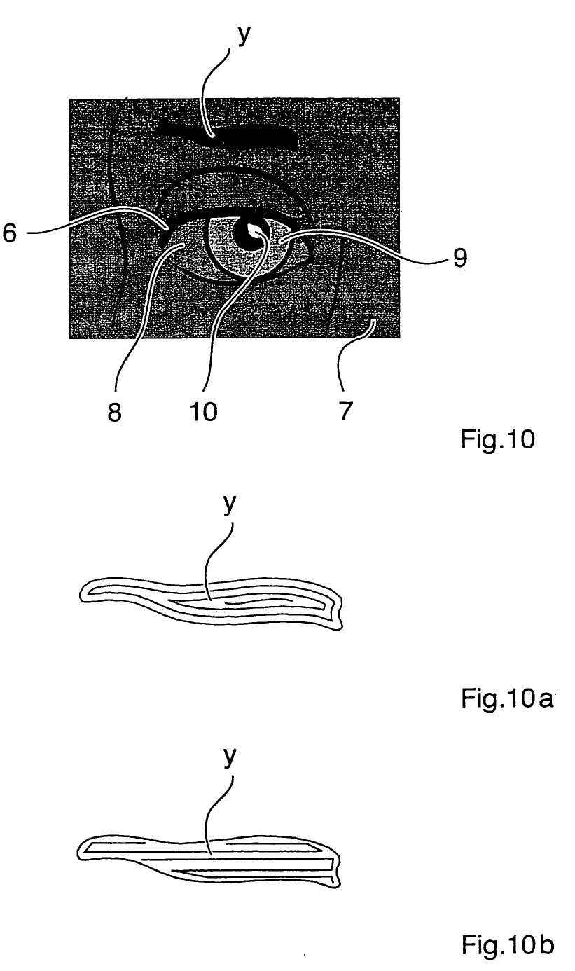

FIG. 10 shows a variant in which the partial surfaces are defined by free graphic design of the original. The inventive image is determined not by mathematically ascertained tonal-value separations from the photographic original, but by design-oriented division of the original into partial surfaces. Means of design, such as shading, colors, etc., are realized by tonal values and partial surfaces. FIG. 10 shows in stylized form the portrait detail shown in FIG. 2, using four tonal values, namely white (10), light gray (9), dark gray (7) and black (6).

### EXAMPLE 8

In contrast to eyebrow “y” shown in FIG. 10, which is represented as an amorphous black surface in the simplest printed image variant, FIGS. 10a and 10b show different embodiments of eyebrow “y” equipped with motif-dependent fine structures. In the corresponding printing plate, not only a depression corresponding to the eyebrow is therefore engraved but also an additional roughness pattern producing the desired fine structures in the printed image.

The form and guidance of the engraving tool can be used to produce said roughness pattern at the base of the partial surfaces produced by the engraving, said pattern firstly serving as an ink trap for the ink and secondly influencing the gloss and visual impression of the printed or embossed image parts. The basic roughness pattern is produced at the base of the cleared surfaces during engraving of the printing plate for example by the method described in WO 97/48555. If the partial surfaces have dimensions as of a length and width of about 100 microns, an ink trap is expedient for example. Engraving tools with a large tip radius and round geometry and closely adjacent clearing paths (for example about 10 microns) achieve smooth engravings that produce smooth and tendentially rather reflective print areas or embossings. If a small tip radius with pointed cutting-edge geometry and further-spaced clearing paths (for example in the magnitude of more than 50 microns) are selected for the engraving tool, however, one obtains rough, structured engravings that produce a matt and diffusely scattering print area or embossing.

The roughness pattern can be executed uniformly in the total printed image, on the one hand, but it is also possible to change the clearing direction in individual partial areas when engraving depressions in the printing or embossing plate. Engravings formed along clearing paths that are linear but rotated for example by 90° produce visually distinguishable print areas or embossings with different light reflection. The same applies to engravings with straight or meandering clearing paths in comparison to spiral-shaped or concentric clearing paths. These effects can not only be used for more appealing or striking design of the blind embossing or print, but simultaneously also increase forgery-proofness. This selectively applied engraving technique can be used to superimpose fine structures selectively on the printed or embossed area that e.g. graphically support the image information but are only clearly recognizable at certain viewing or reflection angles or when viewed with a magnifying glass.

If the abovementioned fine structures are selected as shown in FIGS. 10a and 10b, the mere way of engraving the plate can produce e.g. the eyebrow hairs in the form of a fine structure additionally in the area of the eyebrow. In FIG. 10a the engraving tool has been guided concentrically along the contours of the partial surface to be cleared, while in FIG. 10b the engraving tool has been guided on parallel lines. Other structures, such as oblique hatching, cross screens, etc., are likewise possible.

### EXAMPLE 9

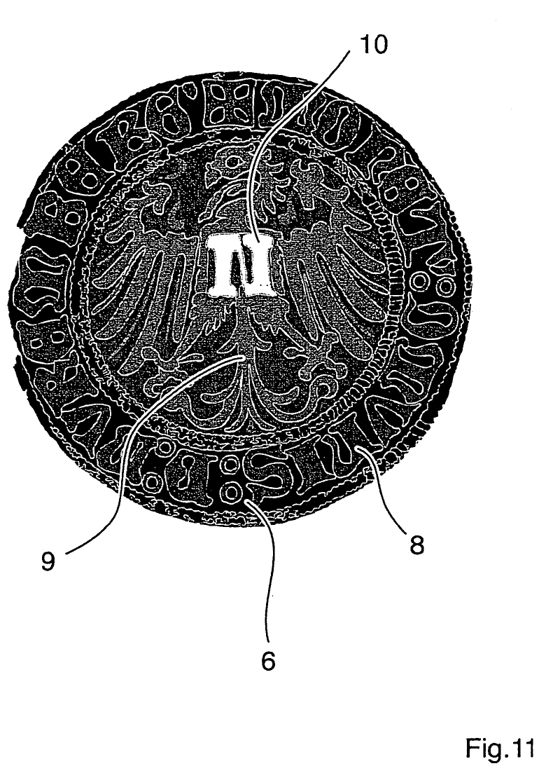

FIG. 11 shows an inventive halftone image having freely designed, motif-dependent partial surfaces as in Example 7. The partial surfaces are assigned four different tonal values. The difference over Example 7 is that it is not a portrait representation but the realization of graphic and alphanumeric elements, each individual element representing a partial surface. The remarks on Example 7 apply analogously.

### EXAMPLE 10

As explained at the outset, the inventive halftone image already has a certain tactility due to the different ink layer thicknesses and embossings of the paper substrate in the area of different tonal values. If the tactility in the inventive printed image is to be increased further, the printed image produced e.g. according to Examples 1 to 9 can be equipped with additional tactile structures. Said structures are taken into account in the engraving of the intaglio printing plate, so that only one printing operation is necessary in this variant too. The size of the structural elements, their tonal value and arrangement are to be regarded in the individual case and oriented toward the desired tactile and visual effects.

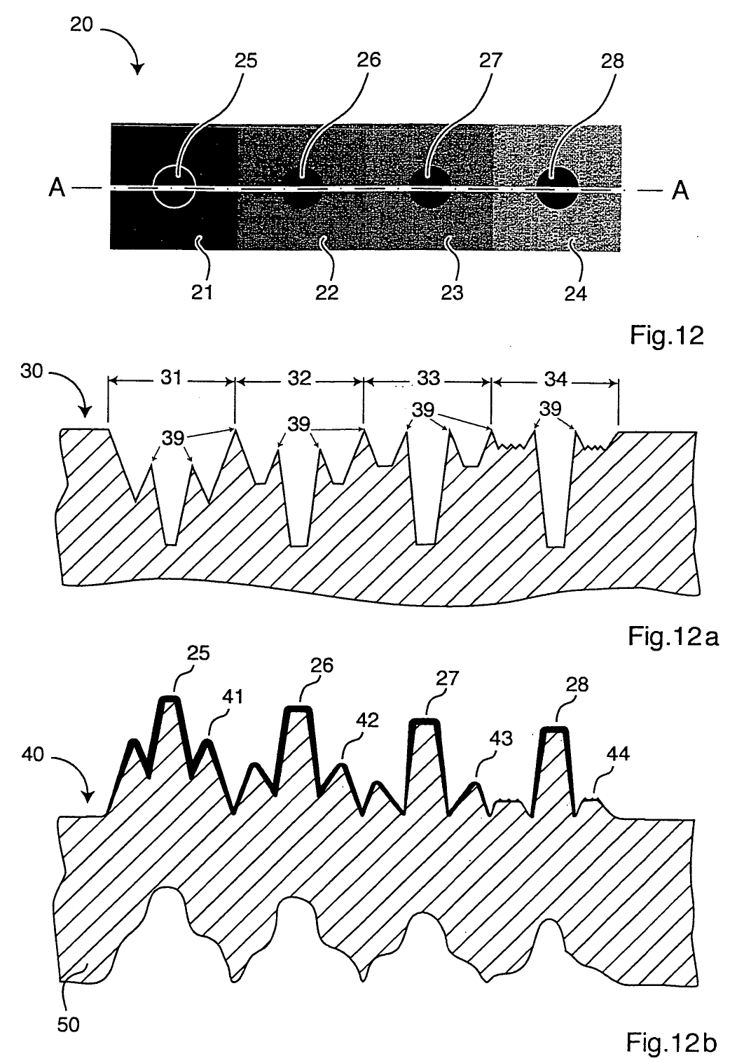

FIG. 12 schematically shows inventive printed image 20 consisting of a gray wedge and additional tactile structural elements. The gray wedge has four squares 21, 22, 23, 24 with four different tonal values. Each square has an edge length of e.g. 5 millimeters and corresponds to one partial surface.

This “halftone image” is already tactilely perceptible due to the relief structure of the printed image. Since the gray values extend continuously from “dark” to “light,” the beginning of the gray wedge, i.e. the black edge, can be readily detected tactilely. However, the further steps cannot be felt as well since they slope and change only in small steps. Smaller black circles 25, 26, 27, 28 are now integrated into the squares in the basic motif as additional tactile structural elements. The additional structural elements are engraved much deeper than would be necessary for representing the tonal value “black.” They thus have a higher relief amplitude than black partial surface 21 of the gray wedge. Structural elements 25 to 28 thus stand in the square partial surfaces like “knobs.” “Knobs” and partial surfaces are delimited by separation edges in the printing plate and appear in exact register in the printed image. They are readily feelable from all directions in all partial surfaces, even the black ones, regardless of contrast or gray-value pattern. Element 25 has optically the same tonal value as square 21 but is perceptible only tactilely, not visually. Not only circles but also other elements such as squares, letters, etc., can of course be used as additional tactile structural elements. Individual elements can be disposed at will in the basic motif. In the present case a tactile structural element is centered in each partial surface. But a tactile structural element can equally well be present only in every second or third square. Structural elements can vary not only in form but also in size. They can also have different tonal values.

In a further embodiment, the partial surfaces described in Example 1 and FIG. 4 can for example be delimited concretely from each other by borders that are tactile and possibly also visible in the printed image. The black and invisible lines described in Example 1 and FIG. 4 are tactile and visually perceptible in this variant. They are preferably lines with very dark tonal values, especially preferably black. This has the advantage that said lines are relatively easily perceptible tactilely in the printed image and can be used as additional tactile structural elements. The lines themselves can for example vary in thickness; they can also be used only in a partial area of the picture motif.

Tactility is advantageously increased by structural elements having a darker tonal value than the adjoining partial surface, since a darker tonal value at the same time means a greater amplitude composed of ink layer thickness and embossing, and can thus be easily perceived tactilely. However, lighter tonal values are also possible. In this case it has a positive effect on tactility if the structural elements with the lighter tonal values are not selected too small, since they are usually less marked and thus harder to detect tactilely than structural elements standing out from the printed image surface. In the present example, the tactile structural elements are perceptible partly only tactilely and partly tactilely and simultaneously visually. Structural element 25 perceptible only tactilely is integrated into first basic square 21. Here, both the structural element and the basic square have the tonal value, black, the structural element having been produced with a deeper engraving and thus having a higher amplitude than the basic square. Structural element and basic square have different ink layer thicknesses, the ink layer thicknesses being selected so great that the ink is no longer transparent, so that structural element and basic square have the same tonal value and are visually indistinguishable in a front view. At a glancing angle the tactile elements might nevertheless be visible due to the different shadow cast, depending on the design, even if they are not distinguishable from the background in a front view. In this case, tactile structural elements can be used to incorporate information visible at a glancing angle, which can serve as an additional authenticity feature. If an additional invisible tactile structure is desired, structural elements must thus be selected that have the same tonal value as their surroundings but a tactilely distinguishable relief.

Since tactile perception is a subjective sensation, a value as of which a relief is perceived tactilely can only be determined within rough limits. Tactile perceptibility of a printed relief depends not only on absolute relief height and individual sensitivity but also on the superficial extent of the printed structure and on whether the printed structure to be felt stands alone or is integrated into relief-like surroundings.

However, the following data can be given as rough guidelines. A printed relief produced by intaglio printing is tactile below a relief height of about 50 microns. Relief areas between about 50 microns and 60 microns are readily feelable. At relief amplitudes greater than 60 microns the intaglio relief is clearly feelable.

FIG. 12a shows inventive intaglio printing plate 30 for producing a printed image as shown in FIG. 12 along cutting line A-A. Engraved areas 31, 32, 33 and 34 each correspond to a square with an incorporated tactile structural element. The particular squares as well as the structural elements are delimited from each other with the aid of separation edges 39 not reaching as far as the plate surface. An ink trap is additionally incorporated in area 34, being shown as a zigzag pattern and producing a surface texture in square 24 (see FIG. 12b).

FIG. 12b shows a cross section of data carrier 40 with the printed image shown in FIG. 12 along cutting line A-A. Substrate 50 has embossings of the paper substrate and ink layers of different extent in dependence on the engraving depth in the printing plate. In the area of black basic square 21 there is very strong embossing with thicker inking 41. Both the embossing and inking 42, 43, 44 decrease for squares 22, 23, 24 lighter in tonal value and to the right thereof. Additional tactile structural elements 25, 26, 27, 28 are recognizable as humps of different height.

It must be heeded that a relief on the data carrier surface does not identically match the engraving depth of the printing plate. The surface relief shown in FIG. 12b is shown in idealized form. The surface relief produced by printing is composed of a compression of substrate material and the applied ink layer. The total height of the relief is based on the normal, i.e. unprinted and unembossed, data carrier surface. In practice, the relief produced on the substrate differs very clearly from the engraving in the printing plate. The reason for the deviations between engraving depth and relief height is that the data carrier is not pressed down to the base of the printing plate engraving during the printing operation and the ink in the depressions of the plate is also not transferred completely to the data carrier. Accordingly, the engraving depth of the plate for relief structures is in the range of about 40 microns to 250 microns, preferably in the range of about 55 microns to 150 microns. It produces relief structures in the range of about 5 microns to 100 microns, preferably 25 to 80 microns. Whether an engraving depth in the fringe range leads to a rather relief-like or rather flat print on the surface of a data carrier also depends in the individual case on the flank steepness of the engraving, the nature of the substrate being printed (strength, plastic deformability) and the ink properties.

Since the relief height achieved in the printing result depends not only on the engraving depth of the printing plate but also on the properties of the substrate and the ink, as mentioned above, an engraving depth of 40 microns can in extreme cases already lead to a relief print, while with different material and printing parameters an engraving depth of 50 microns can still lead to a flat print. In each specific case of application, however, the engravings leading to relief printed image areas are always deeper than those producing so-called flat, nontactile image areas.

### EXAMPLE 11

The following FIGS. 13 to 15 describe by way of example inventive printing plates and printed data carriers. The remarks thereon, in particular general descriptions of the inventive idea, are of course not limited to these special variants.

FIGS. 13 to 15 schematically show by way of example details of an engraved surface of inventive intaglio printing plate 60 for possibly producing a printed image according to FIG. 4. Depression 61 in the plate has a very great engraving depth and produces a section shown e.g. black in the printed image. Directly beside it, separated by separation edge 39, there is engraved area 62 with a smaller engraving depth, which appears e.g. light-gray in the printed image. The light-gray partial surface is followed by a medium-gray partial surface that corresponds to engraved area 63 in the plate. The following dark-gray area corresponds to wide area 64 again engraved more deeply in the plate. After area 65 producing the tonal value, medium gray, the engraved area ends with surface 66 appearing light-gray in the printed image. All engraved areas 61 to 66 are delimited by separation edges 39. The printing plate shown in FIG. 14 corresponds to the plate shown in FIG. 13, the difference being that area 66 has been additionally equipped with an ink trap due to its width, as indicated with a zigzag pattern at the base of the engraving.

Printed data carrier 70 corresponding to said printing plates is shown in cross section in FIG. 15. Substrate 50, bank-note paper here, is printed with transparent intaglio ink and deformed accordingly by the printing operation. As explained above, deep engravings in the plate produce greatly embossed areas with great inking, while less deeply engraved areas emboss the data carrier less greatly, i.e. deform it less, and less ink is also transferred from the plate to the data carrier in said areas. The area designated 61 in FIG. 13 corresponds to area 71 in FIG. 16. The great embossing and thick inking are clearly recognizable. Indentation 79 to the right thereof was produced by separation edge 39. Light-gray printed area 72 with less inking than in area 71 is seamlessly connected to black area 71 in the printed image despite the separation edge. Areas 73 and 75 appearing medium-gray are in turn printed and embossed to a greater extent. Embossed much more greatly and covered with a thicker ink layer, area 74 appears dark-gray in the printed image. Area 76 is only slightly embossed and due to the small ink layer thickness it appears light-gray in the printed image. The printed image surface shows in the depicted area a distinctive relief structure composed of the embossing and the inking. Said relief structure is easily feelable even to the layman, and a clearly detectable security criterion.

1. A data carrier (1) having at least one halftone image produced by intaglio printing and including directly adjacent printed partial surfaces in at least a partial area of the image, characterized in that the partial surfaces have certain tonal values, at least a partial area of the image is tactilely perceptible, and at least three different tonal values are present.

2. A data carrier according to claim 1, characterized in that the halftone image renders a portrait.

3. A data carrier according to claim 1, characterized in that the partial surfaces are derived from a screen superimposed on the halftone original.

4. A data carrier according to claim 1, characterized in that the screen is a pixel screen.

5. A data carrier according to claim 1, characterized in that the screen is derived from image information of the halftone original.

6. A data carrier according to claim 1, characterized in that the partial surfaces are tactile.

7. A data carrier according to claim 1, characterized in that the halftone image has additional tactile structural elements.

8. A data carrier according to claim 1, characterized in that one tactile structural element is disposed in each partial surface.

9. A data carrier according to claim 1, characterized in that the tactile structural element has a greater or smaller amplitude in comparison to the partial surface.

10. A data carrier according to claim 1, characterized in that the tactile structural element is not perceptible visually.

11. A data carrier according to claim 1, characterized in that at least a portion of the partial surfaces is equipped with a roughness pattern that causes visually distinguishable light reflection.

12. A data carrier according to claim 1, characterized in that the halftone image has fine structures superimposed thereon at least in partial areas, which influence its visual appearance and have different orientation in individual partial surfaces.

13. (canceled)

14. (canceled)

15. An intaglio printing plate for printing a halftone image having at least one en-graved area in the printing plate surface, characterized in that the engraved area has, at least in a partial area, directly adjacent partial surfaces with a certain engraving depth, and partial surfaces with at least three different engraving depths are present.

16. An intaglio printing plate according to claim 15, characterized in that the partial surfaces have at least one of the same or different engraving depths.

17. A method for producing an intaglio printing plate according to claim 15 comprising the following steps:
a) converting a halftone original into partial surfaces,
b) assigning certain tonal values to the individual partial surfaces,
c) assigning certain engraving depths to the tonal values, and
d) engraving the partial surfaces with the assigned engraving depth into the printing plate surface.

18. (canceled)

19. (canceled)

20. A data carrier printed with the printing plate according to claim 15.

21. A method for producing a data carrier having a halftone image comprising the following steps:
a) providing a data carrier material,
b) producing an intaglio printing plate according to claim 15, and
c) printing the data carrier material with the intaglio printing plate produced in step b).
